(19) United States
(12) Patent Application Publication
(10) Pub. No.: US 2008/0271852 A1
(43) Pub. Date: Nov. 6, 2008

(54) Apparatus for the Selection and Labelling of Test Tubes for Analysis Laboratories and the Like

(76) Inventor: Luigi Adriano Giacalone, San Cesaro (IT)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/886,252

(22) PCT Filed: Mar. 13, 2006
(86) PCT No.: PCT/IB2006/000550

§ 371 Date: Mar. 24, 2008

(30) Foreign Application Priority Data
Mar. 15, 2005 (IT) RM2005A000116

(51) Int. Cl. B32B 41/00

(52) U.S. Cl. 156/361; 156/350; 156/363

(57) ABSTRACT

This invention comprises a machine for the selection and labelling of test tubes for analysis laboratories and the like. Said machine is designed to provide the doctor taking the blood sample with test tubes already selected and labelled, according to the request by the patient from whom the sample is taken. This invention comprises an automated, computerised machine, comprising loading means for test tubes, means for the selection and transport of the test tubes, means for printing labels and sticking them onto the body of the test tubes, means for depositing the labelled test tubes, electronic control and management means, data entry and video communication means, and independent power means.

This invention relates to a computerised machine designed to provide doctors responsible for taking blood samples with test tubes ready selected and labelled, according to the request of the patient from whom the sample is taken.

Analysis laboratories usually fill with blood one or more test tubes designed for various types of test. These test tubes have different cap colours and sizes, according to the criteria dictated by analysis laboratories.

In a normal, correctly computerised analysis laboratory, the request for the various tests for each patient should be input into a computer, which prints an identifying barcode onto the necessary adhesive labels. The labels are manually stuck onto the test tubes by the doctor who takes the sample or another employee responsible for this task. This entails great wastage of time and a considerable risk of error, because it is sufficient to stick one patient's label onto another patient's test tube, or a label for one type of test onto another test tube, to invalidate the test result, sometimes with dramatic consequences.

Machines that distribute test tubes labelled with barcodes exist, but they are very expensive as they are highly complex. They usually consist of a set of loaders, a robotised selector gripper with the task of picking up the test tubes from the various loaders and positioning them under the labelling device, and a system for the transport and collection of the labelled test tubes.

The loaders are usually made with belts positioned both horizontally and vertically, to which the containers into which the test tubes are loaded are attached. The test tubes are usually loaded by falling, and this solution requires the construction of devices that retain the test tube during the fall, so that it remains available to the selector grippers. However, the assembly often jams because the test tubes do not always fall correctly. This device also takes up space, making the machines cumbersome, and in any event involves additional costs.

The purpose of this invention is to offer a compact, modular, multipurpose machine which provides the doctor taking the blood sample with the test tubes required for the patient in question, ready selected and labelled, with a series of controls which eliminate any kind of error, at very low cost, and with efficient operation.

The machine is based on a new type of modular loader whereby the test tube, inserted into the container from above, can be picked up directly from the loader by a gripper with a simple release mechanism and deposited in the collection drawer by this particular pick-up gripper, which performs all the movement functions of the test tubes, from selection of the correct loader to labelling.

In a currently preferred embodiment, this invention features a modular system of loaders, consisting of a sheet metal drawer with motor-driven pulleys fitted on one side and the same number of free pulleys on the opposite side. A flat belt, on which a series of particular containers designed to contain the test tubes are mounted, is fitted to said pulleys.

Said containers are made of plastic, with a semicylindrical body, having a central opening which allows the passage of the pick-gripper jaws, and four elastic semi-encircling arms which retain the test tube in the container, but let it pass when the time comes for it to be removed.

According to this invention, the pick-up grippers consist of a body mounted on slides or the like which can move both horizontally and vertically. An arm on which a slider runs is fitted on the body of the grippers. Two spring-loaded jaws made of laminated steel are fitted to said slider. Said jaws are designed to hold the test tubes to be picked up at their ends, while a wedge element in the rear part, pushed by a spring, is designed to keep the jaws half-open to facilitate the entry of the test tube when the grippers pick it up, and to close them when the gripper grips the test tube. This system enables a single device to perform all the operations required to select and label the test tubes and deposit them in the collection container on the worktop of the machine.

The slider will conveniently be driven by a gear motor and a cam, controlled by two limit switches, with corresponding connecting rod to slide back and forth, and the slides are driven by stepper motors to take the grippers to the correct operating position. All this is managed by the computerised control unit of the machine.

Also according to this invention, a particular labelling gripper, positioned on the upper part of the machine, grips the test tube to be labelled between the cap and the base via two cup-shaped elements, one of which is motor-driven, while the other revolves on a bearing.

The two cup elements are mounted on sliders; the upper slider is pushed downwards by a spring, while the lower slider is drawn upwards by a cog belt driven by a stepper motor. All this is managed by the electronic control unit of the machine, and controlled by a limit switch.

The labelling grippers are equipped with a rubber roller mounted on arms driven by an actuator or the like, which causes the roller to rest on the test tube when said tube is gripped by the grippers, so that the adhesive label which exits from the print head of an ordinary label printer is inserted between the roller and the test tube and adheres to the test tube.

The grippers deposit the labelled test tubes in a drawer on the worktop of the machine by means of a simple release system.

The device according to the invention also includes electronic management means, data saving and processing means, data entry and video communication means, and means for controlling the pick-up of the test tubes from the drawer.

The machine according to the invention is also equipped with management software, warning lights and buzzers, and suitable sensors designed to control the movements of the various parts, and the normal supply of test tubes and adhesive labels.

Other characteristic purposes and advantages of this invention will become clear from the following description of a currently preferred embodiment, given by way of example but not of limitation, by reference to the annexed figures, wherein:

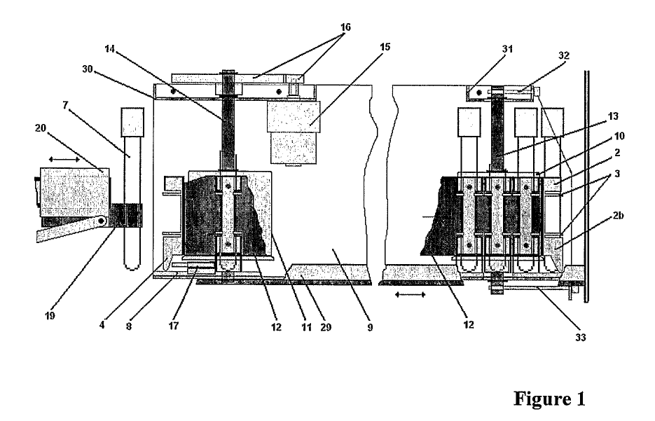

FIG. 1 shows a complete loader.

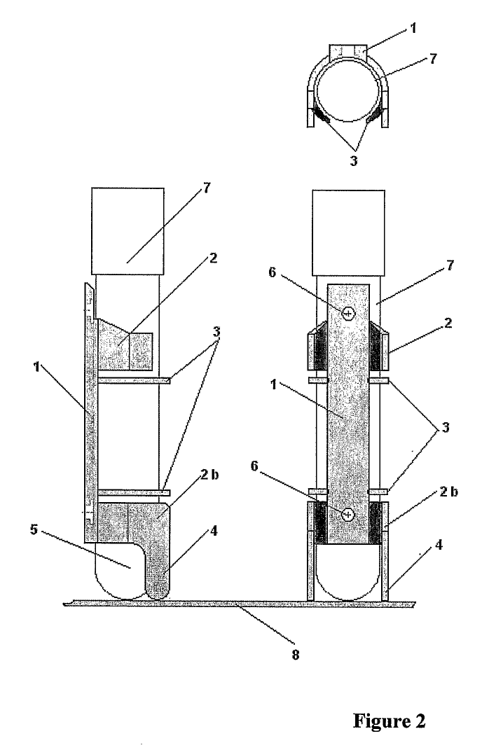

FIG. 2 shows the test tube container from the front, side and in profile.

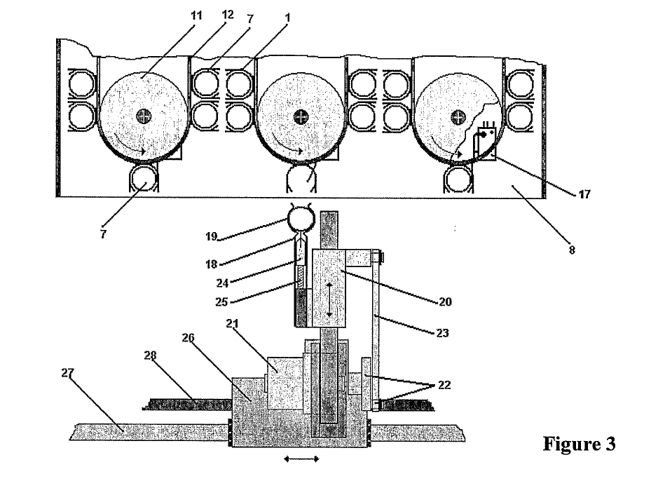

FIG. 3 shows a partial view of a loader with three belts, and the pick-up grippers seen from above.

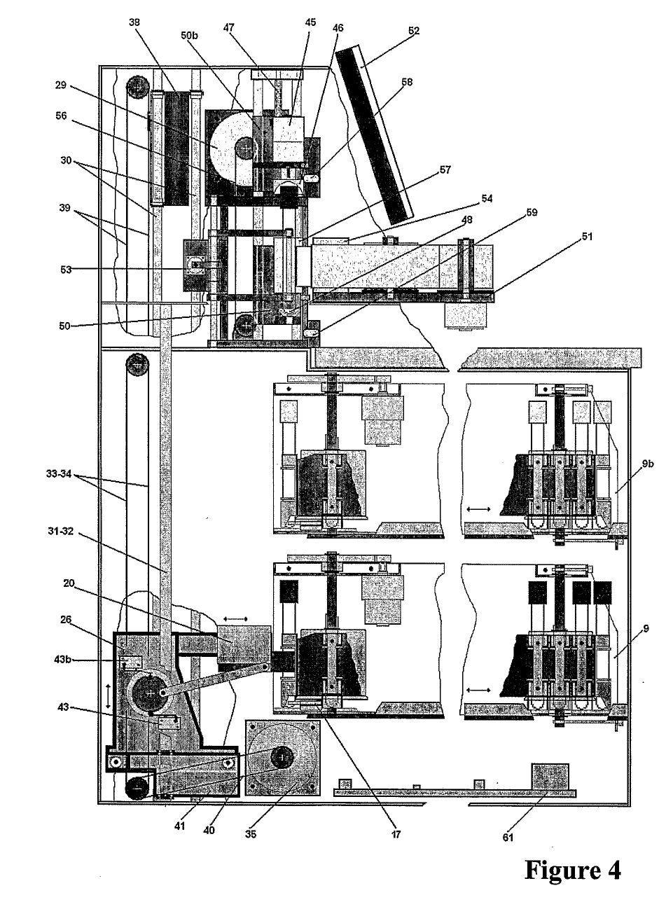

FIG. 4 shows a two-drawer version of the machine, seen from the side.

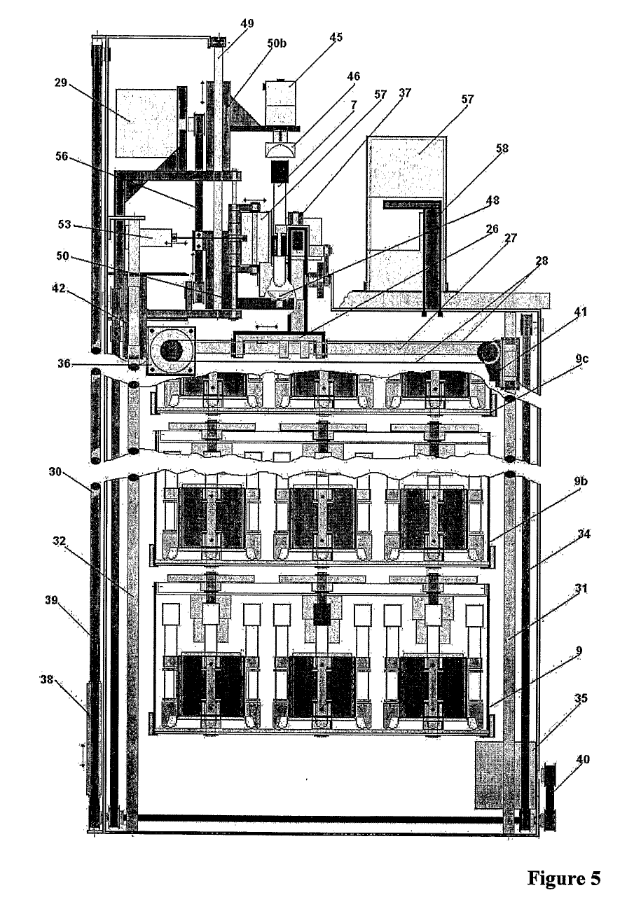

FIG. 5 shows a three-drawer version of the machine, seen from the rear.

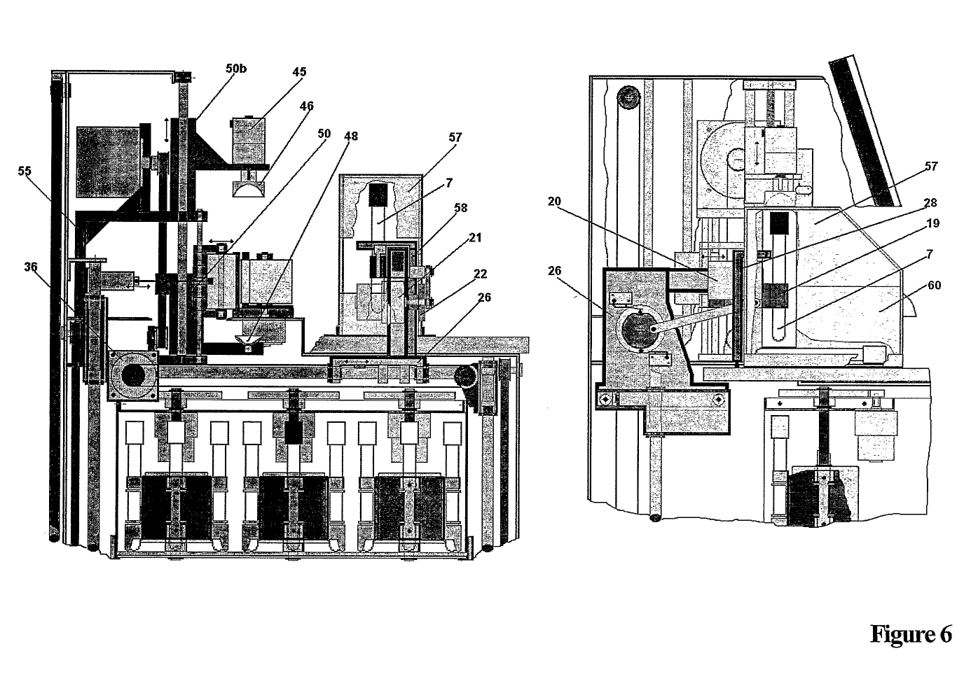

FIG. 6 shows a view of the pick-up grippers which discharge a labelled test tube into the drawer.

With reference to the drawings, and in particular to FIG. 1, the loader is constructed on a U-shaped sheet metal drawer 9, which is mounted on slides 29 to allow loading. Crosspieces 30 and 31 are mounted on the upper part of said loader. A shaft 14 is inserted between crosspiece 30 and base 18, and a pulley 11, driven by gear motor 15 via gear pair 16, is connected to said shaft.

A shaft fitted with two tensioning screws 32 and 33, to which a pulley 10 is connected, is inserted between crosspiece 31 and the base. Belt 12, on which the test tube containers described below are mounted, is inserted onto the two pulleys 10 and 11. Lever-operated microswitch 17 checks for the presence of the test tube and shuts down the gear motor when the test tube pushes the lever, thus controlling the movement of the belt.

As shown in FIG. 2, the test tube container consists of a rectangular section 1, containing fixing holes 6 and 6 b, four semicircular walls 2 and 2 b, and four elastic arms 3 which encircle and retain test tube 7, with the base resting on the top of the drawer. Lower semicircular walls 2 b are fitted with two appendices 4, which act as feet to discharge the weight onto soundproofed base 8, maintaining the belt perfectly perpendicular. Housing 5 allows the passage of the control microswitch lever described above.

FIG. 3 shows the body of pick-up grippers 26 mounted on guides 27 and pulled by cog belt 28, slider 20, driven by gear motor 21 via eccentric bolt 22 and connecting rod 23. Two spring-loaded jaws 19 made of laminated steel are mounted on slider 20. Said jaws are shaped in such a way as to retain the test tube to be picked up at their ends and form a constriction 18, into which wedge element 24 is pushed by spring 25.

FIG. 4 shows the machine in a version with two stacked loading drawers, 9 and 9 b, and grippers 26, which run up and down via sliders 41 and (42 shown in FIG. 5) on guides 31-32, pulled by belts 33-34 which are driven by stepper motor 35 via belt 40. Counterweight 38, which runs on guides 30, hangs from cog belt 39.

FIGS. 4 and 5 show the body of the labelling grippers, with guides 49 on which sliders 50 and 50 b slide. Slider 50 b is pushed downwards by spring 47. Gear motor 45 is mounted on the arm of slider 50 b which causes cup element 26 to rotate, while cup element 48, which turns on a bearing, is mounted on slider 50. Slider 50 is pulled upwards by stepper motor 29, via a cog belt 56, and the test tube is held between cap and base and caused to rotate.

FIG. 4 also shows limit switches 58 and 59, printer 51, with print head 54 and display 52, an actuator 53, which pushes roller 57 towards the body of the test tube to be labelled, and electronic control unit 61.

FIGS. 5 and 6 show the version of the machine with three stacked loading drawers 9, 9 b, and 9 c, and two cylindrical guides 31 and 32, one on either side. Sliders 41 and 42, on which guides 27 are mounted, run vertically on guides 31 and 32. The body of grippers 26 slides horizontally on guides 27, pulled by belt 28, which is driven by stepper motor 36. The whole assembly is pulled up and down by the two belts 33 and 34, driven by stepper motor 35. Counterweight 38, hanging from belt 39 and guided by guides 30, compensates for the weight of assembly 26, 27 and 36, and facilitates the task of stepper motor 35.

As shown in FIGS. 5 and 6, the pick-up grippers take the test tube from the loader and deposit it in the labelling grippers. After labelling, the pick-up grippers take back the test tube and deposit it in container 57, which has two openings to allow the grippers with the test tube to pass. Releasing arm 58 and (bottom) drawer 60 can be seen behind container 57.

FIG. 6 shows labelled test tube 7 being taken into deposit container 57, drawer 60, and releasing arm 58.

Conveniently, as already described, the device will be equipped with a control unit, a software program, presence sensors, limit sensors, positioning sensors, power pack, standby battery, keyboard, warning lamps, warning buzzer, switch, and everything needed for the efficient operation of an electronic device, none of which is described, in order to simplify the drawings and the technical description.

The detailed wiring diagrams of the electronics and the control unit are not shown, because numerous equivalent solutions exist, depending on the choice of the various components available on the market. They are consequently within the reach of one skilled in the art; there are countless solutions, and it would be pointless and limiting to mention them. The same applies to the application software, which could have numerous different configurations.

The operation of the machine according to the invention will now be illustrated by reference to FIGS. 1 to 6.

The software of the control unit should first be programmed so that the machine acquires the various functions, and recognises the position of each type of test tube placed in the loaders.

When the machine is switched on, control unit 61 searches for the references of the sensors, and positions pick-up grippers 26 in a “standby” position close to the loaders, with slider 20 retracted under the control of sensors 43. When the “send” key of control unit 61 is operated, it retrieves all the information relating to the test which the patient has requested from the computer to which it is connected, analyses the data, and “prints” the patient's name and other information relating to the test on display 52 to eliminate the risk of mistaken identity. Then, as the positions of all the test tubes loaded into each loader are stored in the memory, pick-up grippers 26 are moved by stepper motor 35 until spring-loaded grippers 19 are alongside the loader selected. Stepper motor 36 then moves the gripper jaws to the selected belt. The control unit activates gear motor 21 until cam 22 has performed half a turn under the control of sensor 43. The slider advances, and grips test tube 7 between spring-loaded jaws 19. Said test tube pushes wedge element 24 back, allowing spring-loaded jaws 19 to grip the test tube. The control unit then reactivates gear motor 21, causing cam 22 to perform another half turn under the control of sensor 43. The slider then returns, taking the chosen test tube out of the loader.

When microswitch 17 is released from the thrust of the test tube, it closes the contact and activates gear motor 15, which moves belt 12, until it causes a new test tube to push the lever of microswitch 17 (FIGS. 1 and 3) and open the contact.

In the meantime the control unit sends to stepper motors 35 and 36 the pulses required to move pick-up grippers 26 to the two cup elements 46 and 48 (FIG. 4). It then activates gear motor 21, which positions the test tube under the two cup elements. The control unit then activates stepper motor 29, and slider 50 rises until it grips the test tube between the two cups 46 and 48. The test tube pushes slider 50 b to the programmed height, according to the type of test tube, so that the label is glued on at the height established by the analysis laboratory. The test tube remains clamped into the cups under the pressure of spring 47.

As slider 50 b rises, it releases limit switch 58, which sends the signal to the control unit. The control unit starts up gear motor 21, until the signal of limit switch 43 is detected, to retract slider 20 of the empty pick-up grippers. During the retraction movement of slider 20, spring-loaded jaws 19 are forced apart to allow the exit of the test tube, and allowing wedge element 24 to lodge in constriction 18, so that spring-loaded jaws 19 remain half-open to facilitate the subsequent grip.

When the pulse of sensor 43 is detected, the control unit activates actuator 53, which pushes rubber roller 57 towards test tube 7. At the same time said unit starts gear motor 45, which causes the test tube to rotate, and sends the signal to printer 51, which prints the label. The label exits from print head 54, is detached from the silicone-coated tape, and continues straight on until it passes between rubber roller 57 and rotating test tube 7, and adheres to the perimeter of said test tube.

The central unit which dialogues with the printer is informed that printing has taken place and ceases to power actuator 53 and gear motor 45; it activates stepper motor 29 in reverse until the signal of limit switch 58 is detected. It then activates gear motor 21 to pick up the test tube in the gripper jaws until the signal of limit switch 43 is detected, at which point it again activates stepper motor 29 until the signal of limit switch 59 is detected, and the labelling grippers are fully open.

When the signal of limit switch 59 has been detected, the control unit activates stepper motor 35 to lower the grippers by the amount required to allow the test tube to exit from cup element 46 (FIG. 6). It then activates stepper motor 36 to move the pick-up grippers to the right until the test tube is inside container 57, which is fitted with a drawer. The control unit then reactivates gear motor 21 to take slider 20 back. The test tube is retained by arm 58 and is spring-mounted jaws 19 open, allowing said test tube to fall into drawer 60. When jaws 19 are moved apart to allow the exit of the test tube, wedge element 24, pushed by spring 25, will lodge in constriction 19, and the grippers will be ready to pick up another test tube.

The procedure described above is the cycle for the selection and labelling of one test tube. Said cycle will be repeated for as many test tubes as required for the tests.

A photocell (not illustrated) which checks for the presence of test tubes in the drawer is installed on test tube container 57. This device does not allow the changeover to a new patient unless all test tubes have been removed, to prevent errors caused by forgetfulness.

Other sensors are fitted to ensure the correct operation of the device, but are not described because it would be pointless and limiting to mention them in the ambit of the patent.

The machine is also equipped with a particular power pack with a standby battery which allows the current operation to be terminated or the machine to operate independently.

This invention has been described by reference to a currently preferred embodiment. In practice, however, other safety devices, variations and modifications could be introduced as technologies develop, all of which fall within the protection of this patent. For example, the machine could be floor-standing, to serve one or two blood-sampling chair units, placed on a trolley for use in a hospital ward, or mounted under the top of a table, with the upper part projecting from the table top, to form a complete blood-sampling station.

The machine can operate independently or be connected to the booking desk computer.

1. Machine for the automatic selection and labelling of test tubes designed for blood tests and the like, characterised in that it consists of a modular set of test tube loaders and test tube selection means installed below the work surface of the machine, while label printing and sticking means, labelled test tube deposit means, video communication means, a keyboard, warning lamps, and anything else required for efficient operation are installed above said surface.

2. Machine as claimed in claim 1, characterised in that the loaders consist of flat belts on which containers designed to contain various types of test tubes are mounted, said containers being fitted with semi-encircling arms which surround and retain the test tubes, allowing them to pass when they are picked up by the grippers, that the feet of the containers rest on the drawer top to discharge their weight, and that the drawer is mounted on sliding tracks so that the entire loader can be removed for loading.

3. Machine as claimed in claim 1, characterised in that the belts on which the containers are mounted are motor-driven, and their movement is controlled by sensors activated by the body of the test tube.

4. Machine according to claim 1, characterised in that it includes means which automatically detect the required test tube, remove it from the correct loader, and take it to the printer.

5. Machine as claimed in claim 4, characterised in that said means consist of pick-up grippers, with two spring-loaded jaws mounted on a slider, moved forwards and backwards by a gear motor controlled by a limit switch, a cam and a connecting rod, and that a wedge element pushed by a spring is inserted between the two spring-loaded jaws to keep the jaws half-open, ready to grip again.

6. Machine as claimed in claim 5, characterised in that the pick-up grippers are mounted on guides and sliders which cause them to run horizontally and vertically, via cog belts driven by stepper motors and a compensating counterweight.

7. Machine as claimed in claim 1, characterised in that it includes means designed to stick the label onto the test tube, consisting of rotating cup elements, one of which is motor-driven, said elements being mounted on sliders designed to retain the test tube between the cap and the base.

8. Machine as claimed in claim 7, characterised in that said sticking means comprise a rubber roller which rests on the test tube, mounted on arms pushed by an actuator or the like, and that the adhesive label which exits from the printer is inserted between said roller and the rotating test tube.

9. Machine as claimed in claim 8, characterised in that one of the sliders which retains the test tube between the cups is driven by a stepper servomotor via a cog belt, in order to position the test tube at a programmed height in relation to the printer, so that the label can be stuck onto the test tube in a programmed position.

10. Machine as claimed in claim 1, characterised in that the labelled test tubes are deposited by the pick-up grippers in a container fitted with a drawer, and an arm which releases the test tube.

11. Machine as claimed in claim 10, characterised in that the drawer is equipped with means which check for the presence of test tubes, and that said means prevent the changeover to a different patient if tubes are present.

12. Machine as claimed in claim 1, characterised in that it includes electrical power means, equipped with buffer batteries, so that it can terminate the current operation or work independently.

13. Machine for the automatic selection and labelling of test tubes designed to receive blood samples for tests and the like, as claimed in one or more of the preceding claims, substantially as previously described and illustrated by reference to the annexed figures.
